(19) United States
(12) Patent Application Publication
(10) Pub. No.: US 2016/0028133 A1
(43) Pub. Date: Jan. 28, 2016

(54) LITHIUM-AIR BATTERY FOR ELECTRIC VEHICLES AND OTHER APPLICATIONS USING MOLTEN NITRATE ELECTROLYTES

(71) Applicant: Melvin H. MILES, (US)

(72) Inventor: Melvin H. Miles, Ridgecrest, CA (US)

(21) Appl. No.: 14/774,959

(22) PCT Filed: Mar. 12, 2014
(86) PCT No.: PCT/US2014/024288

§ 371 Date: Sep. 11, 2015

Related U.S. Application Data
(60) Provisional application No. 61/779,809, filed on Mar. 13, 2013.

(51) Int. Cl. H01M 12/02; H01M 12/08

(52) U.S. Cl. CPC H01M 12/02; H01M 12/08; H01M 2300/0062; H01M 2220/20

(57) ABSTRACT

A optionally rechargeable molten nitrate electrolyte battery having an anode comprising lithium, a cathode substrate comprising a conductive metal that is compatible with the nitrate melt, an electrolyte comprising lithium nitrate or lithium nitrate mixtures with other nitrates which is capable of becoming an ionic conductive liquid upon being heated above its melting point, a source of oxygen to provide oxygen for reaction at the cathode or within the melt wherein the oxygen is introduced into the battery through the electrolyte.

### FIELD OF THE INVENTION

This invention relates to an optionally rechargeable battery that relies on the use of lithium at the anode, air as a supply of oxygen at the cathode, and a molten nitrate electrolyte that contains lithium ions. Unique for this system is the nitrate electrolyte that can also serve as a secondary source for oxygen at the cathode as well as provide a nitrate ion pathway for oxygen reduction.

### BACKGROUND TO THE INVENTION

The cell discharge reaction of the lithium-air battery involves the oxidation of lithium (Li) at the anode and the reduction of oxygen (O₂) at the cathode to form peroxides (O₂⁼ or oxides (O⁼). The end products of the cell discharge are lithium peroxide (Li₂O₂) and/or lithium oxide (Li₂O). These cell discharge reactions can be expressed as

2Li+O₂→Li₂O₂ (1)

and

2Li+½O₂→Li₂O (2)

These two reactions yield standard cell potentials (E°) of 2.959 V and 2.908 V, respectively, and both cell reactions give high theoretical energy densities (11,425 Wh/Kg and 11,231 Wh/Kg, respectively) that rival the energy density of gasoline. The mass of oxygen is not included in these calculations because, like for the gasoline engine, oxygen is freely available from the atmosphere. Both the anode and cathode reactions are reversible for the lithium-air battery system, thus this battery can function as a rechargeable or secondary battery system.

The technical problems hindering the commercial development of the lithium-air battery include the slow electrochemical kinetics for the reduction of oxygen at the cathode, the precipitation of insoluble lithium oxides in the pores of the typical air cathode, and the low efficiency for the battery reactions. All types of batteries consist of three fundamental components: (1) an anode 2) a cathode and 3) a liquid or solid electrolyte. This electrolyte must be ionically conducting in order to carry electrical charges between the anode and cathode. Any change in one of these three fundamental components results in a major change for the battery system. This invention involves a novel concept for using a molten nitrate electrolyte in the lithium-air battery.

Lithium is not stable in contact with water, thus selected nonaqueous electrolytes are generally used in the lithium-air battery. These electrolytes usually consist of organic liquids that are compatible with lithium metal such as carbonates, ethers, esters, and lactones, but these liquids tend to decompose in the presence of reactive intermediates formed at the oxygen cathode. Furthermore, these organic liquids have relatively high vapor pressures and can be used only near room temperatures where the kinetics of the oxygen electrode reaction is sluggish. This results in a major loss of efficiency for the lithium-air battery. In addition, these organic liquids are flammable and can result in battery fires.

The nitrate ions in molten lithium nitrate electrolytes have been known to serve as the active cathode material for the reaction at the cathode in a number of primary battery cells. U.S. Pat. Nos. 4,190,704, 4,200,686, 4,260,667 and 4,315,059 all address batteries of this type. However such primary battery designs do not add oxygen gas to the electrolyte and do not rely on the sustained introduction of oxygen into the cell to support battery discharge. This limits their applications.

It is an object of the present invention to provide a lithium air battery that addresses the deficiencies of such prior designs.

The invention in its general form will first be described, and then its implementation in terms of specific embodiments will be detailed with reference to the drawings following hereafter. These embodiments are intended to demonstrate the principle of the invention, and the manner of its implementation. The invention in its broadest and more specific forms will then be further described, and defined, in each of the individual claims which conclude this Specification.

### SUMMARY OF THE INVENTION

The main improvements provided by this invention for the lithium-air battery system result from the use of a molten nitrate electrolyte incorporating
an anode electrode comprising lithium in a form that is compatible with selected molten nitrate electrolytes,
a cathode electrode comprising a conductive metal or other conductive substrate that is compatible with the nitrate melt and can optionally serve as a catalytic surface for the oxygen electrode reaction, and
an electrolyte comprising lithium nitrate or an active mixture of lithium nitrate with potassium nitrate, cesium nitrate, or other compatible nitrates with a lithium nitrate content sufficiently high to provide stability for the lithium anode. This lithium nitrate electrolyte or electrolyte mixture is capable of becoming an ionic conductive liquid upon being heated above its melting point,
   and further comprising a source of oxygen such as air to provide oxygen for reaction at the cathode or within the molten nitrate electrolyte wherein the oxygen is introduced into the battery through the electrolyte. In addition to being the major component of the electrolyte, the nitrate ions also serve as a conveyer of oxygen for reaction at the cathode.

This invention addresses a completely different electrolyte for a lithium-air battery that includes molten nitrate liquids containing sufficient lithium ions to provide stability for the lithium anode. The use of molten nitrate electrolytes changes the chemistry that takes place in the lithium-air battery system and help to solve the technical problems of the traditional lithium-air battery. The higher temperatures provided by nitrate melts greatly improve the kinetics for the oxygen electrode reaction. Furthermore, nitrate ions are fully oxidized and do not decompose in the presence of reaction intermediates formed at the oxygen cathode. This also means that nitrate liquids are not flammable and will not cause battery fires. These nitrate melts have low vapor pressures and can be readily used over the 100° C. to 200° C. temperature range. In addition, the atoms present in these nitrate melts are typically 60% oxygen atoms, and this rich supply of oxygen atoms can help to support reactions at the oxygen cathode.

“Oxygen” as used herein can refer to atomic oxygen, oxygen gas (O₂), ionized oxygen and oxygen contained in a molecule or ion as the context requires. “Oxygen” typically refers to oxygen gas.

### Cathode/Oxygen Electrode

The cathode surface or substrate may comprise any conductive metal that is compatible with the nitrate melt. More preferable, the cathode substrate may comprise a metal selected from the group consisting of nickel, cobalt, iron, silver or other compatible transition metals and alloys thereof. Such surfaces may provide a catalytic effect for the cathode reactions. Other than expensive metals such as platinum, it is believed that nickel will provide the best catalytic surface for the reduction of oxygen in nitrate melts. The significantly higher temperatures of these nitrate melts will minimize the need for expensive metal catalysts, such as platinum and ruthenium, for the oxygen reduction reaction.

Another major advantage in using these molten nitrate electrolytes is the fact that 60% of the atoms present in such electrolytes can be oxygen atoms. Therefore, these oxygen atoms can help support the oxygen electrode reaction. The nitrate ions in the electrolyte exist in equilibrium with nitrite ions and oxygen, and this equilibrium can help to support the oxygen electrode reaction. Furthermore, the nitrate ions can be directly reduced at the cathode in place of oxygen to form nitrite and oxide ions. Supplying oxygen directly into the molten nitrate electrolyte converts these nitrite ions back into nitrate ions and chemically results in oxygen reduction. This process provides the same net cathodic reaction as the direct electrochemical reduction of oxygen at the cathode. However, the typically slow electrode reaction of oxygen is replaced by the chemical reduction of oxygen by the nitrite ions within the electrolyte. It is believed that this unique process for oxygen reduction is only provided by molten nitrate electrolytes. The two reactions for this process are given by Equation 8 and 9 below and this is called “the nitrate ion pathway for oxygen reduction”.

The overall effect is for both oxygen gas and nitrate ions to be made available at the cathode for direct electrochemical reduction to form lithium oxides. Oxygen, however, will also be delivered through the electrolyte for a homogeneous chemical reaction with nitrite ions to convert them back to nitrate ions.

The lithium oxides formed at the cathode either by direct oxygen reduction or by nitrate ion reduction will be partially insoluble with lithium peroxide being significantly more soluble than lithium oxide. The less soluble lithium oxide formed at the cathode is expected to remain at the cathode or settle by gravity within the cell. Since the cathode need not be micro-porous, there will be less tendency for the oxide precipitates to block the introduction of further oxygen into the melt by interfering with the cathode permeability. Oxides that remain on the electrode surface or accumulated on cathode collection surfaces can be progressively converted back to the lithium ions and oxygen gas during the charging process.

A possible option is that oxygen evolved during the recharge cycle may be captured in an oxygen absorbent/storage system and reserved for reuse as a source of oxygen during discharge.

### Anode/Lithium Electrode

When the lithium anode electrode is first introduced into the molten nitrate-containing ionic liquid, the lithium metal will rapidly react with the nitrate ions present to form an insoluble lithium oxide layer over the surface of the lithium electrode. For this reason, it is desirable for the electrolyte to contain a sufficient concentration of lithium nitrate. The reaction of nitrate ions with the lithium metal will rapidly decline with the formation of the lithium oxide layer over the surface of the lithium electrode. This protective layer serves as a “solid electrolyte interface” (SEI) through which lithium ions can diffuse from the lithium electrode into or out of the electrolyte during battery operations. If necessary, further protection of the lithium metal from reactive components in the electrolyte could be provided by ceramic coatings which conduct lithium ions but provide a barrier against such reactive components. Also, additives such as calcium ions may be added to the electrolyte to serve as protection for the lithium electrode.

Preferably the electrolyte may contain at least at least a 20 mole % of lithium nitrate, more preferably at least 37 mole % or higher lithium nitrate.

With such an SEI present it is not necessary for a battery according to the invention to have separator positioned in the electrolyte between the cathode and the anode, avoiding employment, for example, of a separator comprising a porous film or a non-woven fabric or of a membrane which is selective to molecular oxygen.

Lithium metal has a melting point of 180.50° C., and the protective lithium oxide film becomes less stable for liquid versus solid lithium. However, this problem may be addressed by using inter-metallic compounds of lithium or lithium alloys as anodes in molten nitrate electrolytes operated at higher temperatures. A preferred anode, for lithium-air batteries using molten nitrate electrolytes is one incorporating a lithium aluminum inter-metallic compound or alloy or other inter-metallic compounds which have a higher melting point than pure lithium. These inter-metallic compounds can, as in the case of aluminum, be formed directly in the nitrate melt by the electro-deposition of lithium metal onto a support electrode. For an aluminum support electrode, a lithium aluminum alloy will form as a surface layer over the aluminum core. The aluminum core itself has a melting point of 660.3° C. and will therefore remain solid with electrolytes operated in a preferred lower range of temperature. The inter-metallic compound formed by electroplating as described can have a lithium-aluminum ratio of 1:1 and a partial melting beginning at 600° C.

The cell voltage in the Li—Al case will be about 0.35 V less than pure lithium due to the formation of the Li—Al inter-metallic compound. This voltage difference may be acceptable for the benefits obtained. Other types of solid lithium alloy anodes can also be used such as Li—Si, Li—Fe, Li—Ca, and Li—B that do not show this voltage difference, but Li—Al is preferred because of its greater stability.

Experimental tests have shown that lithium metal can be reversibly deposited onto various other metals in molten nitrate (e.g. LiNO₃—KNO₃) electrolytes. These experiments showed the reversible formation of alloys of lithium-cobalt (Li—Co), lithium-nickel (Li—Ni), lithium-iron (Li—Fe), lithium-molybdenum (Li—Mo), lithium-tantalum (Li—Ta), and lithium-titanium (Li—Ti).

These materials do not involve inter-metallic compounds based on the fact that the lithium on these metal surfaces behaves electrochemically like pure lithium. Accordingly, these materials could also be used for rechargeable lithium anode materials in association with molten nitrates as long as the lithium is immobilized by the transition metal substrate.

### Recharge Cycle

In the recharge cycle, a current is driven by an external source in a reverse direction through the cell. Lithium oxides present in the cell that are in electrical contact with the cathode surface will release lithium ions and oxygen gas. Simultaneously, lithium ions will reenter the lithium anode electrode, converting to lithium metal. Oxygen from the oxides present at the cathode will evolve from the melt as a gas.

To facilitate this recharge cycle, the oxides formed at the cathode during discharge may be collected on portions or extensions of the cathode, settling under the influence of gravity. This will ensure that such oxides are in close proximity to the cathode during the recharge cycle. To facilitate this reaction the cathode may be may be macro-porous or may be formed with one or more horizontal surface portions for receiving the lithium oxides as they settle under gravity. One such surface portion, optionally in the form of a metallic mesh or screen with larger size openings than the micro-porous pores of conventional porous oxygen cathodes, may be located over a portion of the cell bottom to receive such oxides. The openings in such a lower portion of the cathode may provide a pathway by which oxygen can be introduced into the electrolyte during discharge. Their sizes are chosen so that the passage of oxygen there through is not blocked by the deposit of oxides.

### Electrolyte

Pure lithium nitrate has a melting point of 253° C. It would be preferable for the battery to operate at a lower temperature if practical. Eutectic mixtures of lithium nitrate combined with other compatible eutectic salts can provide an electrolyte that is molten at a lower temperature. As one preferred mixture, an electrolyte containing 59 mole % potassium nitrate and 41 mole % lithium nitrate has a melting point under normal conditions of 124° C. Also attractive is eutectic mixture containing 39 mole % potassium nitrate, 37 mole % lithium nitrate, and 24 mole % cesium nitrate with a melting point of 97° C. Both of these low melting electrolytes contain sufficient LiNO₃ to provide stability for the lithium anode. To ensure that the electrolyte remains molten and to take advantages of the higher conductivity that would arise with higher temperatures, batteries according to the invention would preferably be operated at temperatures sufficiently above their melting points, however operation at 100° C. to 200° C. would be possible for the eutectic containing cesium nitrate.

In addition to true eutectic mixtures other mixtures of nitrate salts can also be used as the electrolyte.

Although other molten nitrate compositions can be used, the lithium nitrate-potassium nitrate eutectic (LiNO₃—KNO₃) with a melting point of 124° C. and the lithium nitrate-potassium nitrate-cesium nitrate eutectic (LiNO₃—KNO₃—CsNO₃) with an even lower melting point of 97° C. are the most desirable. Both of these nitrate electrolytes offer a 4.5 V range between the reduction of lithium ions and the oxidation of nitrate ions.

The nitrate melt should not contain any significant amounts of NaNO₃ due to potential destabilizing reactions of sodium ions with the lithium anode. For example, sodium ions react with the lithium metal to form much more reactive sodium metal. Furthermore, sodium metal would also be deposited at the anode during the battery recharging.

Similarly chloride ions in the melt should be avoid because they lead to an aggressive attack and corrosion of the protective lithium oxide layer on the lithium metal in the anode.

As in other lithium-air battery systems, both Li₂O and Li₂O₂ are likely produced by the reduction of oxygen at the cathode. However, lithium peroxide decomposes to lithium oxide and oxygen at temperatures higher than 195° C. Accordingly, insoluble lithium oxide is believed to be the main final product in molten nitrates above such an operating temperature. Furthermore, it is known that the electrochemical reduction of the nitrate ion to the nitrite ion produces the oxide ion and not the peroxide ion, thus Li₂O would be the main product and not Li₂O₂ for the nitrate ion pathway for oxygen reduction.

The protection of the lithium anode depends on the solubility of the oxides present on the lithium surface. Ideal solubility calculations yield accurate predictions for the solubility of oxides, as well as other substances, in molten nitrates. Examples of several calculations of ideal solubility for substances important in this patent disclosure are given in Table I. As shown in Table I and confirmed by experiments, Li₂O is much less soluble than K₂O or K₂O₂.

TABLE I
Ideal solubility of several metal oxides in molten nitrates at
500 Kelvin (223° C.).

| Metal Oxide | X₁^{a} | m₁ (moles/kg)^{b} | Tₘ (K) | ΔH_{fus} (kJ/mol) |
|---|---|---|---|---|
| CaO | 1.23 × 10⁻⁷ | 1.40 × 10⁻⁶ | 2886 | 80 |
| MgO | 1.80 × 10⁻⁷ | 2.05 × 10⁻⁶ | 3098 | 77 |
| Li₂O | 3.46 × 10⁻⁵ | 3.95 × 10⁻⁴ | 1843 | 58.6 |
| K₂O | 3.73 × 10⁻² | 4.42 × 10⁻¹ | 1013 | 27 |
| K₂O₂ | 1.21 × 10⁻¹ | 1.57 | 763 | 25.5 |
| Cs₂O | 1.87 × 10⁻¹ | 2.62 | 768 | 20 |
| KO₂ | 3.13 × 10⁻¹ | 5.20 | 653 | 20.6 |

Note:
Experimental data was not available for Li₂O₂ but the measured solubility was significantly greater than for Li₂O in molten nitrates.
^{a}Ideal solubility in mole fraction given by lnX₁ = ΔH_{fus} (T − Tₘ)/RTTₘ
^{b}Ideal solubility in molal units (moles/Kg) given by m₁ = 11.403X₁/(1 − X₁)

Due to the plentiful potassium ions in the lithium nitrate-potassium nitrate eutectic (59 mole % potassium nitrate), potassium oxide (K₂O), potassium peroxide (K₂O₂), and potassium superoxide (KO₂) are possible products of the cathode reaction. However, these potassium oxides are all much more soluble than Li₂O (see Table I). Thus insoluble Li₂O would likely be the main final product of the reaction at the cathode in molten nitrate systems containing lithium nitrate-potassium nitrate mixtures. Preferably, the amount of water in the electrolyte should be minimized. According to one variant, this condition may be advanced by desiccating any oxygen-containing gas being provided to the melt. Due to the elevated operating temperature of the electrolyte, moisture when present will tend to be purged through conversion of the water to steam. Additionally, evolved oxygen generated during recharging will help to purge out moisture.

### Priority and Incorporation by Reference

This disclosure has been filed as part of an application which claims priority from an earlier patent filing. Priority is claimed in respect of the following earlier U.S. provisional patent application 61/779,809, filed Mar. 13, 2013. The applicant claims the benefit of that earlier patent application.

The applicant hereby incorporates by reference from such document all elements referred to in Articles 11 (1)(iii)(d) or (e) of the PCT and all parts of the description, claims or drawings referred to in Rule 20.5(a) of the Rules under the PCT not otherwise contained herein but which is or are completely contained in such earlier application from which priority is claimed.

The foregoing summarizes the principal features of the invention and some of its optional aspects. The invention may be further understood by the description of the preferred embodiments, in conjunction with the drawings, which now follow.

Wherever ranges of values are referenced within this specification, sub-ranges therein are intended to be included within the scope of the invention unless otherwise indicated or are incompatible with such other variants. Where characteristics are attributed to one or another variant of the invention, unless otherwise indicated, such characteristics are intended to apply to all other variants of the invention where such characteristics are appropriate or compatible with such other variants.

### BRIEF DESCRIPTION OF THE FIGURES

FIG. 1 is a schematic depiction of a battery with two electrodes and a lithium nitrate-potassium nitrate eutectic mixture serving as the electrolyte. Air from a diffuser is shown as being passed through the electrolyte while the battery is operating in discharge mode.

FIG. 2 is a schematic depiction of the battery of FIG. 1 during the recharging portion of the cycle.

FIG. 3 is a schematic depiction of the batteries of FIGS. 1 and 2 showing the optional recapture and storage of oxygen evolved during the recharge cycle.

FIG. 4 is a schematic depiction of a half-cell experimental arrangement wherein voltage and current for the half cell are measured in order to provide a cyclic voltammogram.

FIG. 5 is a cyclic voltammogram showing current flow as a function of applied voltage for components present in a battery according to the invention using a cobalt electrode and a lithium nitrate-potassium nitrate eutectic mixture serving as the electrolyte. This electrochemical system is operated through one cycle of scanning the potential corresponding to the charging and discharging reactions of a battery according to the invention.

### DESCRIPTION OF THE PREFERRED EMBODIMENTS

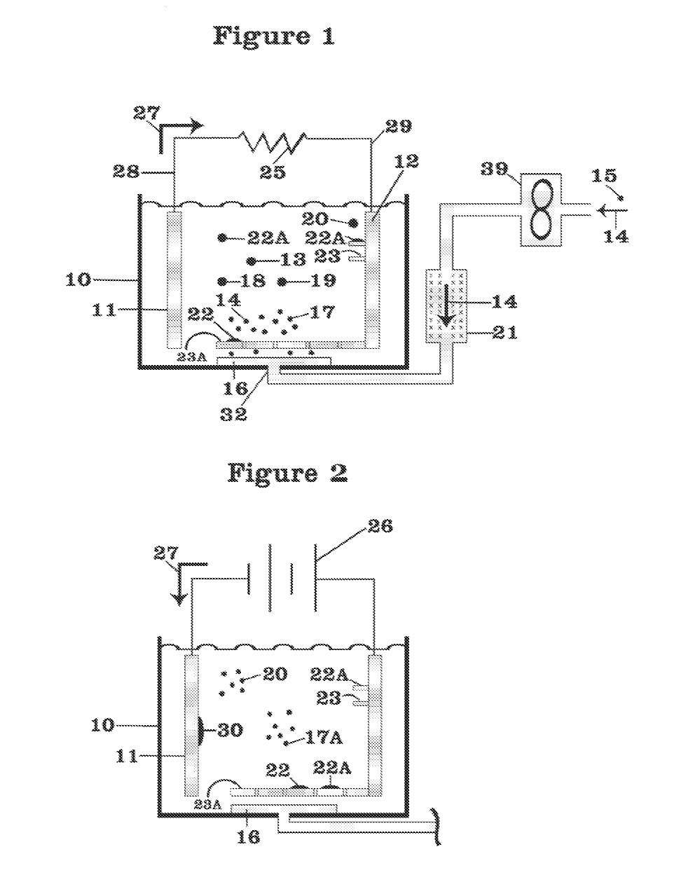

FIG. 1 shows a battery assembly or cell 10 with two electrodes 11, 12, an anode 11 and cathode 12, and a lithium nitrate-potassium nitrate eutectic mixture serving as the electrolyte 13. The battery 10 is operating in discharge mode. Air 14 from an external source 15, after being dried in a desiccator 21, enters the cell through an access opening or air inlet 32 and then passes through a diffuser 16 whereby the air 14 or oxygen 17 mixes with the electrolyte 13. Preferentially, the diffuser 16 as the source of air 14 or oxygen 17 within the cell is located to cause the air 14 or oxygen 17 preferentially to rise through the electrolyte 13 in the vicinity of the cathode 12 to facilitate the reduction of the oxygen 17 in the air 14 at the cathode 12.

As described above, the oxygen 17 present in the electrolyte 13 is believed to also react with nitrite ions 18 converting such ions into nitrate ions 19. The nitrate ions 19, in turn, react at the cathode to release a doubly negative charged oxygen ion which then combines with lithium ions 20 present in the electrolyte 13 to form lithium oxide 22 and possibly some lithium peroxide 22A. The insoluble portions of such oxides 22, 22A remain on the cathode surface or precipitate out into the electrolyte 13 and settle towards the bottom of the battery assembly 10.

The cathode 12 is optionally formed of an electrolyte-compatible conductive material, for example nickel, which provides horizontal surfaces 23 onto which the precipitated particles of the oxides 22, 22A may settle. While these may be in the form of ledge surfaces along the face of the cathode 12, a preferred arrangement is to provide an extended horizontal surface portion 23A of the cathode 12 along the base of the cell 10. The horizontal surface portions 23 receive the lithium oxides as they settle under gravity. The horizontal surfaces 23 may also be within the cathode body when the cathode 12 is macro-porous with open cells that do not become occluded or plugged-up by the accumulation of precipitates.

The diffuser 16 may be located beneath such horizontal surface portion 23A with air 14 released by the diffuser 16 percolating through perforations in the horizontal surface portion 23A. Turbulence thereby created will help make contact between the air 14 and the electrolyte 13 for the purposes of facilitating the homogenous reaction of the oxygen 17 with nitrite ions 18 to form nitrate ions 19 as well as the direct reaction of oxygen at the cathode electrode.

During discharge electrons 27 pass out of the cell through the anode electrical connection 28 and then pass through an electrical load 25 as part of an external circuit as the electrochemical reactions occur within the battery. The electron flow then enters the cathode 12 through the electrical connector 29 completing the circuit.

In FIG. 2 the electrical load 25 of FIG. 1 is replaced with a current source 26 which causes electrons to flow 27 in a reverse direction through the cell 10. During this phase air 14 or oxygen 17 may optionally no longer be passed into the electrolyte 13 through the diffuser 16. The action of the electron flow 27, however, will form oxygen 17A, releasing lithium ions 20, out of the oxides 22, and 22A present in the cell in the vicinity of the cathode 12. In particular, oxide particles 22, 22A that have settled onto horizontal surface portions 23, 23A of the cathode 12 will disassociate resulting in the formation of oxygen 17A and the release of lithium ions 20. Simultaneously, lithium ions 20 will be deposited on the anode 11 as metallic lithium 30. With sufficient lithium 30 restored to the anode 11 the battery will have been recharged into a condition suitable for subsequent discharge.

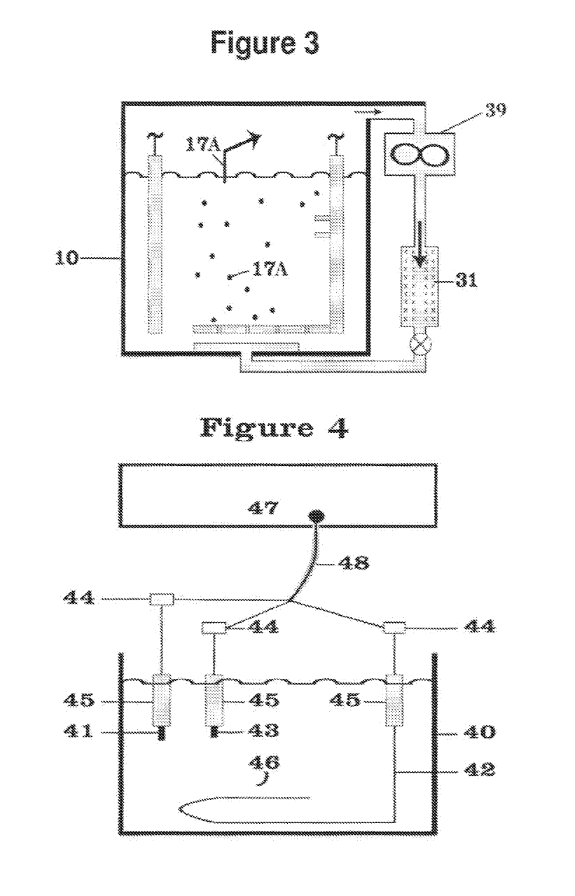

FIG. 3 depicts an optional arrangement wherein the oxygen released from the cell 10 during the recharge cycle of FIG. 2 is transferred to an oxygen storage container 31 for optional reuse as a source of oxygen 17 during a subsequent discharge stage.

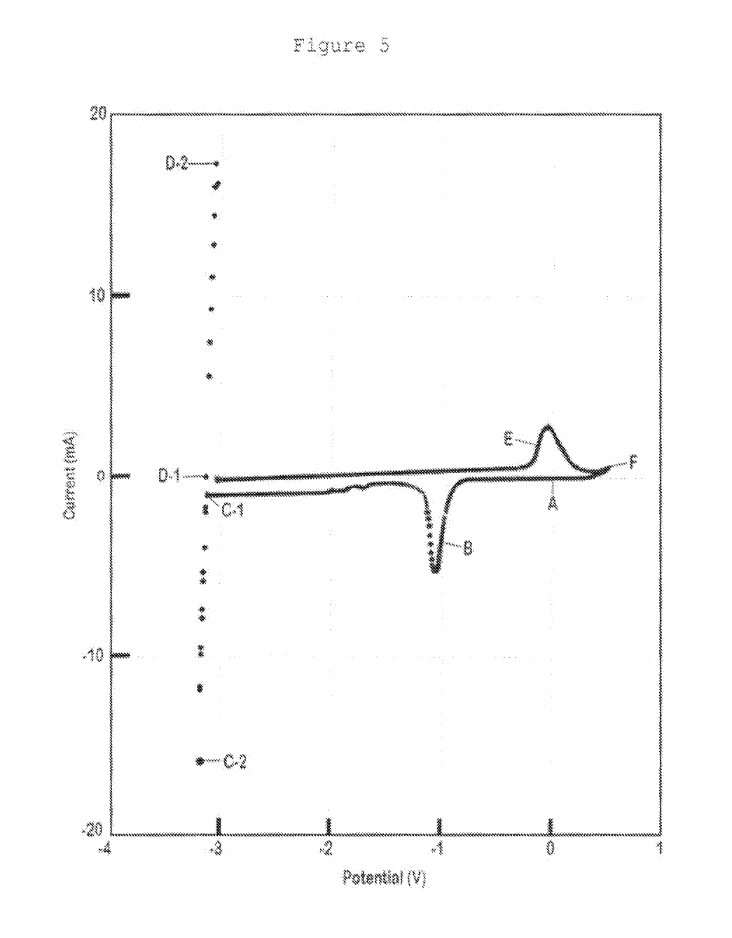

In FIG. 4 a half-cell experimental arrangement for generating a cyclic voltammogram includes: a container 40 with a working electrode 41—the electrode being investigated which in this case was a length of cobalt wire; and a counter electrode 42, in this case a platinum wire coil, immersed in an electrolyte 46. Also separately immersed in the electrolyte 46 is a reference electrode 43, which in this case is nickel wire with a nickel oxide coating positioned in the electrolyte 46 at a location where it will be undisturbed by the greater part of chemical reactions occurring within the cell. The reference electrode 43 permits measurement of the electrical potential near the working electrode 41. An external potentiostat 47 connected through connectors 44 and wiring 48 linearly varies the potential of the working electrode 41 with respect to the reference electrode 43 with the current flow through the cell being measured simultaneously.

The working electrode 41 is contained within a shrink-fitted Teflon sleeve 45 that provides a defined exposed electrode area on the portion of the cobalt wire 41 that is fully submerged in the electrolyte 46. The exposed area of the cobalt electrode was 0.20 cm². The reference electrode 43 is similarly contained within a shrink-fitted Teflon sleeve 45.

The current flow progresses through the following stages as shown in FIG. 5:

A—negative potential scan begins at 0.0 Volts, with an applied potential which is becoming more negative to the left in the Figure at the rate of 50 mV/s. The current flow is initially near 0.0 milliAmps.
B—the current passes through a short negative surge with spontaneous reduction of lithium nitrate to lithium nitrite while forming a lithium oxide (Li₂O) layer on the working electrode 41
C-1—After returning to near zero negative milliamps following the excursion, the current starts to rise to high negative values commencing at C-1 when the voltage reaches approximately −3.1 V. This corresponds to the deposition of lithium metal on the working electrode.
C-1 to C-2—reduction of lithium ions to form lithium metal at the working electrode continues in conjunction with increasing current flow; the direction of the potential scan is reversed on reaching −3.2 V at C-2
D-1 to D-2—reversible oxidation of lithium metal to form lithium ions at the beginning and continuation of the reverse potential scan. From the minimum positive current, D-1, towards D-2 the positive current increases to a maximum value as the absolute value of the applied voltage is decreased. The current then drops abruptly to near zero as the lithium metal on the working electrode is depleted.
E—oxidation of the lithium oxide (Li₂O) formed at stage B occurs to form lithium ions and oxygen gas. This corresponds to the conversion of lithium oxide back to lithium ions and oxygen as in the recharging of a cell.
F—potential scan is reversed again at +0.5 V and the potential cycle ends at the starting potential (0.0 V).

The reactions at C-1 to C-2 and D-1 to D-2 correspond to the charging and discharging steps for the lithium 40 deposits on the anode 11. The reactions at B and E also correspond to discharging and recharging reactions occurring at the cathode electrode in a normal battery.

FIG. 5 shows the excellent reversibility for the lithium electrode reaction in a LiNO₃—KNO₃ electrolyte 43 at 227° C. This cyclic voltammogram was obtained using a potential scan rate of 50 mV/s. Initially, the potential scan registered negative currents on the ammeter 46. The negative current near −3.2 Volts is associated with the reduction of lithium ions 20 to form lithium metal 30 represented by the following reaction:

Li⁺+e⁻→Li (3)

The current spike at about −3.2 V potential on the return portion of the test, section D-1 to D-2 when the potential scan registered positive currents on the ammeter corresponds to the reverse reaction involving the oxidation of the lithium metal 30 back to lithium ions 20.

This experiment gave a reversible Li⁺/Li voltage potential of −3.137 V with respect to the Ni/NiO reference electrode 48 that was immersed the molten LiNO₃—KNO₃ electrolyte 43. The sharp change in current at the negative end of this potential scan indicates fast electrode kinetics for the Li⁺/Li reaction in molten nitrates. Electrochemical Impedance Spectroscopy (EIS) measurements for this same experiment verified fast electrode kinetics for the reversible lithium anode in molten nitrate electrolytes.

FIG. 5 is also instructive in respect of the reactions occurring at the oxygen cathode in the molten LiNO₃—KNO₃ electrolyte. In this experiment, free dissolved oxygen was removed from the electrolyte by diffusing argon gas through the melt for about 15 minutes.

The reduction peak near −1.1 V corresponds to the reduction of nitrate ions (NO⁻₃) to form nitrite ions (NO⁻₂) in the form of LiNO₂ and insoluble Li₂O. This is represented by

2Li⁺+LiNO₃+2e⁻→LiNO₂+Li₂O (4)

Further reaction is blocked by the insoluble Li₂O layer formed on the surface of the cobalt electrode. On the subsequent positive portion of the potential scan this insoluble Li₂O layer is converted back to lithium ions and oxygen at a potential near −0.2 V. This reaction can be summarized by

Li₂O→2Li⁺+½O₂+2e⁻ (5)

which is simply the reverse of the oxygen electrode reaction when Li₂O is the product. This corresponds to the charging reaction for the oxygen electrode when the cell reaction involves the formation of Li₂O as shown in Equation 2. Thus, this reaction is readily reversible as required for the lithium-air battery. In fact, repeated cycles of the potential scan shown in FIG. 5 showed no measurable changes. From FIG. 5, we can estimate that the reversible cell voltage for the lithium-air battery under these conditions would be close to 2.9 V in molten LiNO₂—KNO₃ at 227° C.

For studies where the LiNO₃—KNO₃ electrolyte is exposed to air provided over the upper surface of the melt, negative currents are observed due to the reduction of oxygen. Rather large reduction currents of about 10⁻² A/cm² are measured for the reaction of oxygen. In fact, when the LiNO₃—KNO₃ electrolyte is exposed to air, negative currents for the reduction of oxygen are even observed on the anodic (positive) potential scan. These studies all indicate good electrode kinetics for the oxygen electrode reaction in molten LiNO₃—KNO₃. Furthermore, expensive electrode catalysts such as platinum and gold will likely not be required to obtain fast oxygen electrode reactions. Good results can be obtained for the oxygen electrode reaction in molten nitrate electrolyte by less expensive cathode structures such as nickel, cobalt, or stainless steel screens.

It is important to note that there was no blocking of the electrode surface by insoluble Li₂O in these studies of the electrochemical reduction of oxygen in molten nitrate electrolytes. This suggests that the much more soluble Li₂O₂, and not Li₂O, was formed initially by the cathode reaction: 2 Li⁺→O₂+2e⁻→Li₂O₂. Any conversion of Li₂O₂ into Li₂O would then take place elsewhere in the electrolyte and not at the electrode surface. These experimental observations suggest that the clogging of pores in the cathode structure would not be a problem for oxygen reduction in molten nitrate electrolytes in contrast to the organic electrolytes used for lithium-air batteries. This represents another major advantage for the use of molten nitrate electrolytes in lithium-air battery systems.

Another major advantage for molten nitrate electrolyte for lithium-air batteries is the following equilibrium reaction:

2NO⁻₃ [symbol] 2NO⁻₂+O₂ (6)

that has been reported for molten nitrate systems. This equilibrium reaction is an internal source for oxygen that will help replenish the oxygen supply in the nitrate system. Catalysts can be used to increase the rates of this equilibrium reaction. As oxygen is consumed by the reduction reaction at the cathode, this equilibrium will supply replacement oxygen to the cathode. Thus larger current densities can be attained in this molten nitrate electrolyte than typical in organic electrolytes near room temperatures that rely on oxygen permeable cathodes. In addition, the nitrate ions which are a major component of these electrolytes, can also be reduced at the cathode form to nitrite ions and oxygen ions as part of the nitrate ion pathway for the reduction of oxygen (see Equation 8 and 9).

A possible modification of this invention is to use other molten nitrate eutectics or mixtures. However, any nitrate eutectic used must contain sufficient LiNO₃ to stabilize the lithium anode and serve as an abundant supply of lithium ions for the anodic reactions. The amount of LiNO₃ required is not known exactly, but mixtures with 37 and 41 mole % LiNO₃, as shown in Table II, perform well. Many different nitrate eutectics have been investigated for use in lithium-air batteries, and some of these are shown in Table II.

TABLE II
Molten Nitrate Eutectics Investigated.

| Electrolyte | Mole % | Melting Point (° C.) |
|---|---|---|
| LiNO₃—KNO₃—CsNO₃ | 37-39-24 | 97 |
| LiNO₃—KNO₃ | 41-59 | 124 |
| LiNO₃—RbNO₃—CsNO₃ | 64-29-7 | 145 |
| LiNO₃—CsNO₃ | 60-40 | 170 |
| LiNO₃—RbNO₃ | 66-34 | 180 |

Any of these listed compositions would be suitable for use as the electrolyte for the present invention, but the lower melting eutectics are preferred. Compositions other than these precise eutectic compositions can also be used.

No eutectic melts involving sodium nitrate (NaNO₃) are included in Table I because it was found both by thermodynamic calculations and experimental measurements that this nitrate salt makes the lithium anode less stable. This is because the sodium ions can enter into a displacement reaction with lithium metal to form the more reactive sodium metal or sodium-lithium alloys. This displacement reaction can be represented by

Na⁺+Li→Na+Li⁺ (7)

Sodium metal (Na) has a much lower melting point (97.80° C.) than lithium metal and is much more reactive. Therefore, Equation 5 must be prevented from occurring by keeping sodium ions out of the nitrate melts.

The last three molten nitrate eutectics shown in Table II offer no obvious advantages over the first two because of their higher melting points. Nitrates of alkaline earth metals such as magnesium nitrate, Mg(NO₃)₂, and calcium nitrate, Ca(NO₃)₂, were also considered, but they offer no significant advantages in melting points or in most other properties for applications in lithium-air batteries. However, additions of those nitrates increase the stability of the lithium anode due to the low solubility of their oxides, CaO and MgO, in nitrate melts (see Table I).

### Other Issues

### Presence of Lithium Nitrate

An important factor for the rechargeable lithium anode in molten nitrate electrolyte used in lithium-air is that the nitrate electrolyte must contain sufficient amounts of LiNO₃. The presence of lithium nitrate in the electrolyte insures an adequate supply of lithium ions and the formation of a stable, insoluble protective film of lithium oxide (Li₂O) on the lithium anode. Use of the preferred eutectic mixtures of LiNO₃—KNO₃ or LiNO₃—KNO₃—CsNO₃ as the electrolyte are compatible with the formation of this protective film.

### Deformation of Lithium Anode

Shape changes can be a problem for repeated cycles of charging and discharging of anodes consisting of Li—Al, Li—Co or other lithium anode materials. For example, an aluminum sheet electrode tends to bend and curl on cycling due to formation of Li—Al within the aluminum metal. Therefore, the Li—Al, Li—Co, or Li—Fe anode may preferably be formed into small metal particles contained within a metallic containment screen. This containment screen can be formed from Ni, Co, Fe or other transition metals compatible with the electrolyte. Another method of stabilizing the anode is by bonding of the metal particles to a conductive substrate such as a nickel screen. Lithium-intercalation anodes as presently used in lithium-ion batteries can also be used to minimize deformation effects.

### Water

It is known that water (H₂O) creates problems for lithium-air battery systems. Methods used in lithium-air batteries to minimize the effect of water include the removal of water from the inlet of air and the encapsulation of the lithium anode with ceramic materials that block the contact of water with the lithium anode. These same methods can be used for lithium-air batteries using molten nitrate electrolytes. Furthermore, the high operating temperature up to 200° C. is well above the boiling point of water (100° C.), and this will help to minimize the water content in the molten nitrate electrolyte. In addition, the oxygen gas production during the charging process will help to drive off water.

### Temperature of the Electrolyte

It is possible that the molten nitrate electrolyte will need to be maintained in the liquid state and not be allowed to freeze absent good engineering design for the cells. Good insulation around the battery will help maintain the high temperature. Also, the heat generated by the charging process will also help maintain the liquid state. Additional means may include an internal battery heating system run off the electrical grid or provided by a small internal generator or current source. In high current situations where internal resistance of the cell generates excessive heat, then cooling may be required to keep the battery in its preferred temperature operating range (100° C. to 200° C.).

### Important Reactions for Nitrate in Pathway

Without wishing to be bound by any specific period, the following reactions and processes are believed to take place within batteries according to the invention.

The lithium-air battery according to the invention is able to operate with molten nitrates due to a protective lithium oxide layer that spontaneously forms at the lithium anode and acts as a solid electrolyte interface (SEI). This solid electrolyte layer readily transports lithium ions back and forth from the anode to the electrolyte as needed by the battery reactions.

Oxygen can be supplied from the atmosphere of air outside the battery to the cathode portion of the battery by being percolated through the molten electrolyte in a manner analogous to introducing air into an aquarium. The air may be a natural form or may be treated so as to be enriched in oxygen.

The oxygen from whatever source is reduced at the cathode to be available to form the end products of lithium peroxide (Li₂O₂) and or lithium oxide (Li₂O). The overall reactions can be expressed as shown previously by Equations 1 and 2. According to a further feature of the invention, it is believed that the overall electrode reaction occurring at the cathode is: O₂+4 Li⁺+4e⁻=2 Li₂O. In molten nitrates, an entirely different reaction mechanism is possible at the cathode referred to as the “nitrate ion pathway for oxygen reduction” which involves the electrochemical reduction of nitrate ions. This reaction step is represented by:

2LiNO₃+4Li⁺+4e⁻→2Li₂O+2LiNO₂ (8)

The second step is the direct homogeneous chemical reaction of the nitrite ions (NO₂⁻) with oxygen supplied separately or subsequently at the cathode:

2LiNO₂+O₂→2LiNO₃ (9)

The sum of these two steps, Equations 8+9, gives the same net result as O₂+4 Li⁺+4e⁻=2 Li₂O. Catalysts are known which greatly improve the kinetics for the reaction of nitrite ions with oxygen.

It can be shown from thermodynamics that the standard Gibbs energy change (ΔG°) for Equation 9 is −158 kJ mol⁻¹, thus this reaction will be spontaneous. Furthermore, from K_{eq}=e^{-ΔG°/RT} the amount of LiNO₂ remaining at equilibrium will be very small with the ratio of the concentration of LiNO₂ to LiNO₃ ([LiNO₂]/[LiNO₃]) being only about 10⁻²⁰.

### CONCLUSION

The foregoing has constituted a description of specific embodiments showing how the invention may be applied and put into use. These embodiments are only exemplary. The invention in its broadest, and more specific aspects, is further described and defined in the claims which now follow. These claims, and the language used therein, are to be understood in terms of the variants of the invention which have been described. They are not to be restricted to such variants, but are to be read as covering the full scope of the invention as is implicit within the invention and the disclosure that has been provided herein.

1-18. (canceled)

19. A lithium-air rechargeable battery with a molten nitrate electrolyte, comprising:
a) an electrolyte comprising lithium nitrate which electrolyte is capable of becoming an ionically conductive liquid containing lithium ions and nitrate ions upon being heated above its melting point,
b) a reversible anode comprising lithium and a solid electrolyte interface (SEI) of lithium oxide capable of transferring lithium ions back and forth between the lithium anode and the molten nitrate electrolyte,
c) a compatible cathode with a cathode surface capable of transferring electrical charge to and from oxygen and lithium oxides as well as ions such as nitrate ions,
d) oxygen present within the electrolyte to serve as an internal source of oxygen for providing oxygen to be delivered to the cathode for reaction whereby during battery discharge one or more lithium oxides are formed; and
e) an oxygen inlet for introducing oxygen gas into the electrolyte from an external source to replenish the oxygen depleted from the internal source and to provide a portion of the oxygen which reacts at the cathode to produce one or more lithium oxides.

20. The battery of claim 19, wherein the oxygen which serves as an internal source of oxygen within the electrolyte during battery discharge is provided by nitrate ions present within the electrolyte which are converted to nitrite ions and lithium oxide at the cathode.

21. The battery of claim 20, wherein during battery discharge oxygen introduced into the electrolyte reacts with said nitrite ions to form nitrate ions and thereby replenish oxygen depleted from the internal source of oxygen.

22. The battery of claim 20, further comprising collection surfaces within the cell electrolyte for collecting the lithium oxides formed during battery discharge, said surfaces being electrically connected to the cathode for the lithium oxides to be dissociated into lithium ions and oxygen during battery recharging.

23. The battery as in claim 19, wherein the electrolyte comprises as well as said lithium nitrate salt one or more additional nitrate salts compatible with battery operation which form a mixture with a melting temperature below that of pure lithium nitrate.

24. The battery of claim 23, wherein the electrolyte comprises a mixture of lithium nitrate and potassium nitrate.

25. The battery of claim 24, wherein the electrolyte further comprises cesium nitrate.

26. The battery of claim 23, wherein the cathode surface comprises a conductive metal selected from the group consisting of nickel, iron, cobalt, copper, silver, chromium, platinum, and ruthenium and other transition metals or combinations thereof.

27. The battery of claim 26, wherein the anode comprises a lithium-aluminium alloy.

28. The battery of claim 27, wherein the anode comprises a material selected from the group consisting of a lithium-silicon alloy, a lithium-calcium alloy, a lithium-magnesium alloy, and lithium-boron alloy.

29. The battery of claim 28, wherein the cathode comprises a horizontal surface portion upon which oxides which are formed during discharge will be collected to facilitate the recharge cycle by positioning such oxides in electrical connection with the cathode during the recharge cycle.

30. The battery of claim 29, comprising calcium or magnesium ions in the electrolyte in an amount sufficient to provide calcium or magnesium oxide as a portion of the stable layer of lithium oxide formed on the lithium anode.

31. The battery of claim 30, wherein the electrolyte of the battery is substantially free of sodium ions, chloride ions and water to provide stability for the lithium anode.

32. The battery of claim 31, wherein the battery is devoid of a separator positioned in the electrolyte between the cathode and the anode.

33. A method of using the molten salt electrolyte battery of claim 19, wherein the electrical connections of the battery of claim 19 are connected to each other through an external circuit to permit a battery discharge current to flow through the battery while providing oxygen to oxygen dispenser from the external oxygen source.

34. A method of using the molten salt electrolyte battery of claim 19, wherein the electrical connections of the battery of claim 19 are connected to each other through an external circuit which includes an electromotive source which causes current to flow through the battery to effect battery recharging by dissociation of lithium oxide present on the lithium oxide collection surfaces.

35. A method of operating a molten salt electrolyte battery, the battery having:
a) an electrolyte comprising lithium nitrate which electrolyte is capable of becoming an ionically conductive liquid upon being heated above its melting point,
b) an anode comprising lithium that is compatible with the electrolyte for introducing lithium ions into the electrolyte, and
c) a cathode electrode comprising an electrically conductive surface material that is compatible with the electrolyte
comprising the step of providing during battery discharge oxygen to the electrolyte for reaction at the cathode to form lithium oxides by introducing oxygen into the battery through the electrolyte.

36. The method as in claim 35, wherein the oxygen which is provided to the electrolyte reacts with nitrite ions present therein to form nitrate ions which provide at least a portion of the oxygen within the electrolyte for reaction at the cathode.
